(19) United States
(12) Patent Application Publication
(10) Pub. No.: US 2019/0179848 A1
(43) Pub. Date: Jun. 13, 2019

(54) METHOD AND SYSTEM FOR IDENTIFYING PICTURES

(71) Applicant: Lenovo (Beijing) Co., Ltd., Beijing (CN)

(72) Inventor: Xiao XU, Beijing (CN)

(21) Appl. No.: 16/213,249

(22) Filed: Dec. 7, 2018

(30) Foreign Application Priority Data
Dec. 7, 2017 (CN) 201711290400.0

(51) Int. Cl. G06F 16/538; G06K 9/62; G06F 16/583

(52) U.S. Cl. CPC G06F 16/538; G06F 16/583; G06K 9/6215

(57) ABSTRACT

A method includes obtaining an image selected from among the stored images, determining a target content of the selected image, identifying one or more images corresponding to the target content of the selected image, and displaying the one or more identified images.

### CROSS-REFERENCE TO RELATED APPLICATION

This application claims priority of Chinese Patent Application No. 201711290400.0, filed on Dec. 7, 2017, the entire content of which is incorporated herein by reference.

### TECHNICAL FIELD

The present disclosure relates to a method and a system for identifying pictures.

### BACKGROUND

Using electronic devices to take pictures has become a habit of many users. The number of photos accumulated in electronic devices tend to increase as the user takes more pictures. These pictures generally include a plurality of themes. For pictures of a same theme, there are usually multiple pictures containing the same or similar content. For example, a continuous shooting may take multiple pictures containing similar content.

Moreover, besides a basic function of picture backup or storage, existing electronic devices also have a picture search function so that the user can find desired pictures.

As such, it becomes a concern of many users that it can be difficult to search relevant pictures from a large number of pictures quickly. The existing electronic devices usually display multiple pictures indiscriminately, resulting in a poor user experience.

### SUMMARY

In accordance with the disclosure, one aspect of the present disclosure provides a method of retrieving stored images in an electronic device. The method includes obtaining an image selected from among the stored images, determining a target content of the selected image, identifying one or more images corresponding to the target content of the selected image, and displaying the one or more identified images.

In accordance with the disclosure, another aspect of the present disclosure provides an electronic device. The electronic device includes a processor, a memory coupled to the processor and configured to store images, and a display device coupled to the processor and memory device. The display device can display the images as stored in the memory device. The processor is configured to obtain an image selected from the images stored in the memory device, determining a target content of the selected image, identify one or more images from the memory device that correspond to the content of the selected image, and send the one or more identified images to the display device for displaying.

In accordance with the disclosure, another aspect of the present disclosure provides provided a terminal device. The terminal device includes a processor and a memory coupled to the processor. When instructions stored in the memory are executed by the processor, the processor can obtain an image selected from the images stored in the memory device, determining a target content of the selected image, identify one or more images from the memory device that correspond to the content of the selected image, and send one or more identified images to the display device for displaying.

### DESCRIPTION OF THE DRAWINGS

To clearly understand the present disclosure and advantages thereof, the present disclosure is described below with reference to the accompany drawings, in which:

FIG. 1 illustrates an application scenario of a method for identifying images and a system for identifying images according to an embodiment of the present disclosure;

FIG. 2 illustrates a flowchart of a method for identifying images according to an embodiment of the present disclosure;

FIG. 3A illustrates a flowchart of displaying a number of images satisfying a condition from a first set of images according to an embodiment of the present disclosure;

FIG. 3B illustrates a flowchart of a method for identifying images according to another embodiment of the present disclosure;

FIG. 3C illustrates a schematic view of displaying images according to an embodiment of the present disclosure;

FIG. 3D illustrates a flowchart of displaying a number of images satisfying a condition from a first set of images according to an embodiment of the present disclosure;

FIG. 3E illustrates a flowchart of displaying a number of images satisfying a condition from a first set of images according to another embodiment of the present disclosure;

FIG. 3F illustrates a flowchart of displaying a number of images satisfying a condition from a first set of images according to another embodiment of the present disclosure;

FIG. 4 illustrates a block diagram of a system for identifying images according to an embodiment of the present disclosure;

FIG. 5A shows a block diagram of a first display module according to an embodiment of the present disclosure;

FIG. 5B illustrates a block diagram of a system for identifying images according to another embodiment of the present disclosure;

FIG. 5C illustrates a block diagram of a first display module according to another embodiment of the present disclosure; and

FIG. 6 shows a block diagram of a computer for implementing a method for identifying images according to an embodiment of the present disclosure.

### DETAILED DESCRIPTION

Embodiments of the present disclosure with reference to the accompanying drawings are described below. It should be understood, however, that these descriptions are merely illustrative and are not intended to limit the scope of the present disclosure. In addition, in the following description, descriptions of well-known structures and techniques are omitted so as not to obscure the concept of the present disclosure.

Terms used herein are only for describing embodiments only but not intended to limit the present disclosure. The terms “including”, “comprising”, and the like, as used herein, indicate the presence of stated features, steps, operations, and/or components, but do not exclude the presence or addition of one or more other features, steps, operations, or components.

Unless otherwise defined, all the technical and scientific terms used herein have the same or similar meanings as generally understood by those skilled in the art. It should be noted that terms used herein should be interpreted as having meanings that are consistent with the context of the present specification and should not be interpreted in an idealized or overly rigid manner.

In terms of a statement such as “at least one of A, B, and C, etc.,” it should be generally interpreted in light of the ordinary understanding of the expression by those skilled in the art. For example, “a system including at least one of A, B, and C” shall include, but is not limited to, a system including A alone, a system including B alone, a system including C alone, a system including A and B, a system including A and C, a system including B and C, and/or a system including A, B, and C, etc. In terms of a statement similar to “at least one of A, B or C, etc.”, it should generally be interpreted in light of the ordinary understanding of the expression by those skilled in the art. For example, “a system including at least one of A, B or C” shall include, but is not limited to, a system including A alone, a system including B alone, a system including C alone, a system including A and B, a system including A and C, a system including B and C, and/or a system including A, B, and C, etc. It should also be understood by those skilled in the art that all transitional words and/or phrases representing two or more alternative items, whether in the description, the claims or the drawings, should be understood as including one of these alternative items, or including any one of or all these alternative items. For example, the phrase “A or B” should be interpreted to include possibilities of including “A” or “B”, or including “A” and “B”

A number of block diagrams and/or flowcharts are shown in the drawings. It should be understood that some blocks and/or flows or combinations thereof in the block diagrams and/or the flowcharts can be implemented by computer program instructions. These computer program instructions may be provided to a processor of a general-purpose computer, a special-purpose computer, or other programmable-data processing device such that, when executed by the processor, these instructions may be configured to generate a device that can implement functions/operations illustrated in these block diagrams and/or flowcharts.

Thus, embodiments of the present disclosure may be implemented in the form of hardware and/or software (including firmware, microcode, etc.). In addition, embodiments of the present disclosure may in a form of a computer program product on a computer-readable medium that stores instructions. The computer program product can be used by or in connection with a program instruction execution system. In the context of the present disclosure, a computer-readable medium may be any medium that can contain, store, communicate, propagate, or transport the program instructions. For example, the computer-readable medium may include, but is not limited to, an electronic, magnetic, optical, electromagnetic, infrared or semiconductor system, apparatus, device, or propagation medium. Optionally, examples of the computer-readable medium may include: a magnetic storage device such as a magnetic tape or a hard disk (HDD); an optical storage device such as a compact disk read-only memory (CD-ROM); a memory such as a random-access memory (RAM) or a flash memory; and/or a cable/wireless communication link.

Embodiments of the present disclosure provide a method for identifying images and a system for identifying images. The method for identifying images includes receiving search data for identifying a target image; receiving a first set of images corresponding to the search data in an image gallery based on the search data; and displaying a number of images satisfying a condition from a first set of images. It should be understood that terms “image” and “image” in the present disclosure can be interchangeable and can also be substituted by another term with a similar meaning.

In some embodiments, the search data may be input by the user to search for an image. For example, the search data may be content input by the user into an electronic device, and the electronic device can retrieve images from images stored in the electronic device according to the content. In some other embodiments, the search data may be determined based on an image selected from a plurality of images. For example, the electronic device can obtain an image selected by the user from the images stored in the electronic device. The electronic device can determine a target content of the selected image. The target content can be understood as a type of search data. The electronic device can retrieve images from the images stored in the electronic device according to the target content.

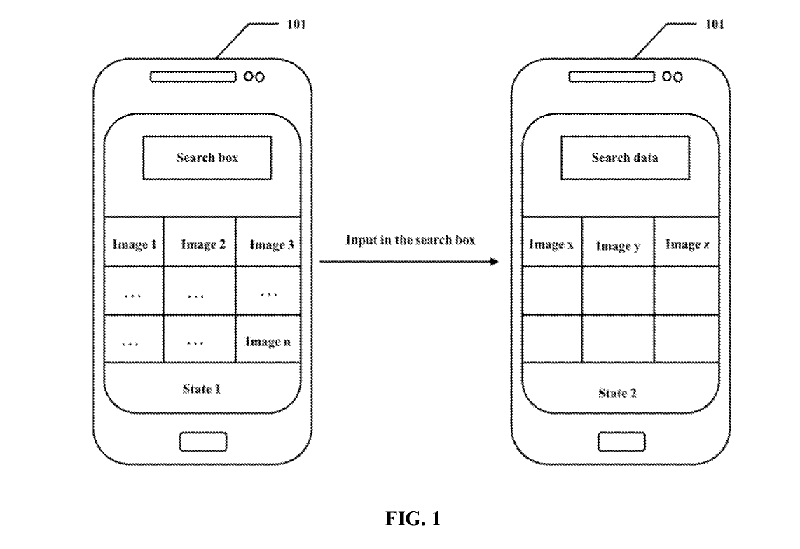

FIG. 1 illustrates an application scenario of a method for identifying images and a system for identifying images according to an embodiment of the present disclosure. It should be noted that FIG. 1 is merely an example of a scenario to which an embodiment of the present disclosure may be applied to help those skilled in the art to understand the technical content of the present disclosure, but it does not mean that embodiments of the present disclosure cannot be applied to other devices, system, environment or scenario.

As shown in FIG. 1, in a state 1, an electronic device 101 may store n images, for example, image 1 to image n. A user can search for an image desired by the user through a search box of the electronic device 101. For example, after the user inputs a content in the search box, an image x, an image y, and an image z may be displayed in a state 2.

According to an embodiment of the present disclosure, the n images may also be stored in a cloud platform or other electronic devices. When the user searches for a target image through the search box of the electronic device 101, the cloud platform or other electronic devices that stores the image may send images to the electronic device 101 through, saving a storage space of the electronic device 101.

According to an embodiment of the present disclosure, the electronic device 101 may be a smart phone, a notebook computer, a tablet computer, a desktop computer, or another type of electronic device.

With rapid development of artificial intelligence technology, electronic devices can continuously improve their performance through using a machine learning method. In the field of image recognition, a deep learning method in machine learning can be implemented to tag images in a set of images (e.g., an image gallery) and write tag results in the electronic devices. Such that, through the image tags, the electronic devices can search for an image desired by the user. According to an embodiment of the present disclosure, classification of the tags may be defined in advance, and N different subtitles or descriptive statements may be generated for each tag, and a database of subjects may be established. Through pre-training models that support multi-label classification, a database of tags can be established.

According to an embodiment of the present disclosure, the user can search for a corresponding tag to retrieve an image. For example, if the image gallery contains images of ducks. By identifying ducks, the electronic device 101 can display to the user an image related to ducks. According to an embodiment of the present disclosure, it is also possible to establish an association map of each tag and corresponding approximate type of each tag to realize a fuzzy or approximate search. For example, ducks are similar to yellow rubber ducks and ducklings. By identifying ducks, the electronic device 101 can show the user images related to ducks, yellow rubber ducks and ducklings.

According to embodiments of the present disclosure, after the user inputs a search content, images corresponding to the search content is often directly displayed without performing a further processing. However, according to embodiments of the present disclosure, a first set of images related to the search content may be obtained after the user inputs the search content, and thereafter, each of the first set of images to be displayed may be further processed to determine whether the first set of images satisfy a condition. When an image among the first set of images satisfies the condition, the image satisfying the condition may be displayed. For example, by identifying ducks, x selected images related to ducks may be obtained in advance, and thereafter, it is also required to determine whether each of the x pre-selected images related to ducks satisfy the condition. Among the first set of images, a number of images satisfying the conditions may be displayed.

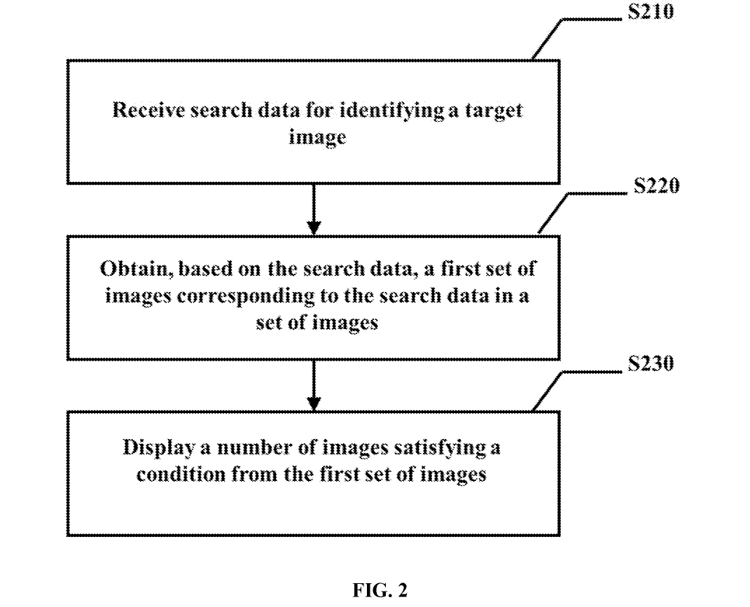

FIG. 2 illustrates a flowchart of a method for identifying images according to an embodiment of the present disclosure.

As shown in FIG. 2, the method includes operations S210-S230.

In S210: Search data for identifying a target image is received.

In S220: Based on the search data, a first set of images corresponding to the search data in a set of images are obtained.

In S230: Among the first set of images, a number of images satisfying a condition are displayed.

According to embodiments of the present disclosure, the first set of images related to the search content may be obtained after the user inputs the search content. Thereafter, each of the first set of images to be displayed may be further processed to determine whether the first set of images satisfy the condition. When an image among the first set of images satisfies the condition, the image satisfying the condition may be displayed.

According to an embodiment of the present disclosure, the condition is not limited herein. For example, the condition may be that whether a pixel or quantity of the image satisfies a certain pixel or quantity requirement, whether a brightness of the image satisfies a certain requirement, or whether the selected images include a plurality of images that are the same. In the case that the selected images include a plurality of images that are the same, one or more images from the plurality of same images may be selected for display.

According to the embodiment of the present disclosure, displaying a number of selected images may be displaying one image, or displaying multiple images. The number of displayed images may be determined according to the condition. For example, when condition is relatively strict, there may be only one image in the first set of images that satisfies the condition. At this time, the one image satisfying a condition may be displayed.

According to an embodiment of the present disclosure, from the first set of images, a number of images satisfying a condition are selected as target images. As such, a plurality of images may be selected based on a search word, and the selected images may then be further filtered. Therefore, the images displayed are the images that truly satisfy the desire of the user, improving the user experience.

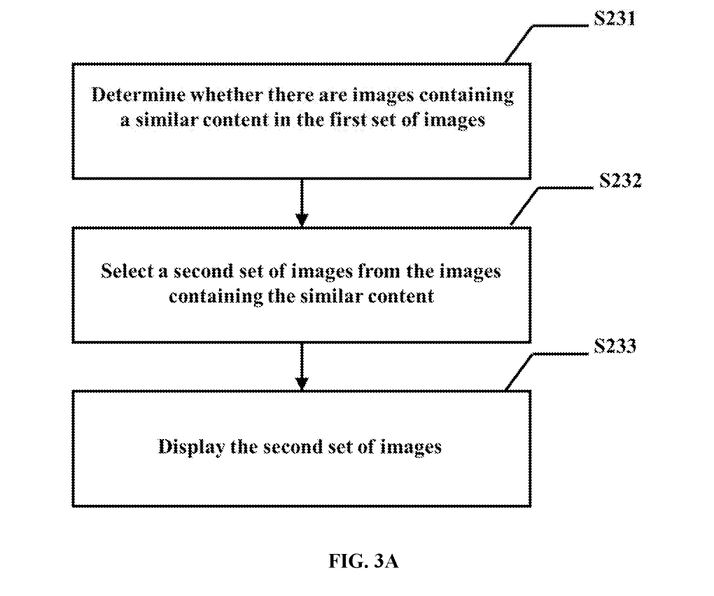

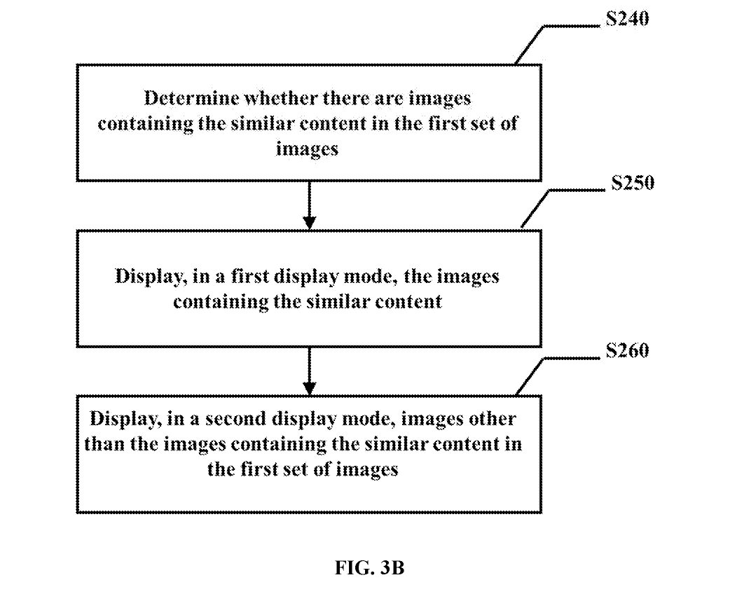

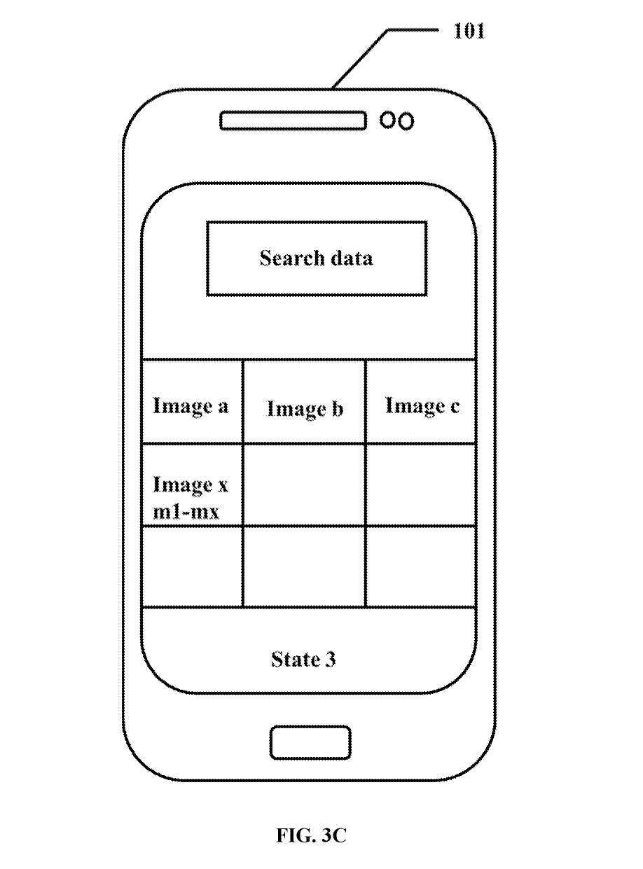

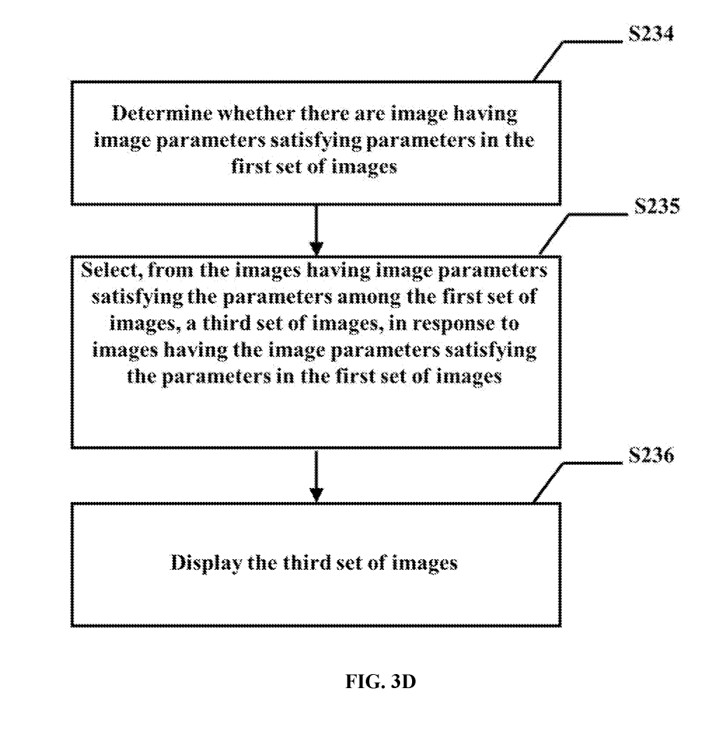

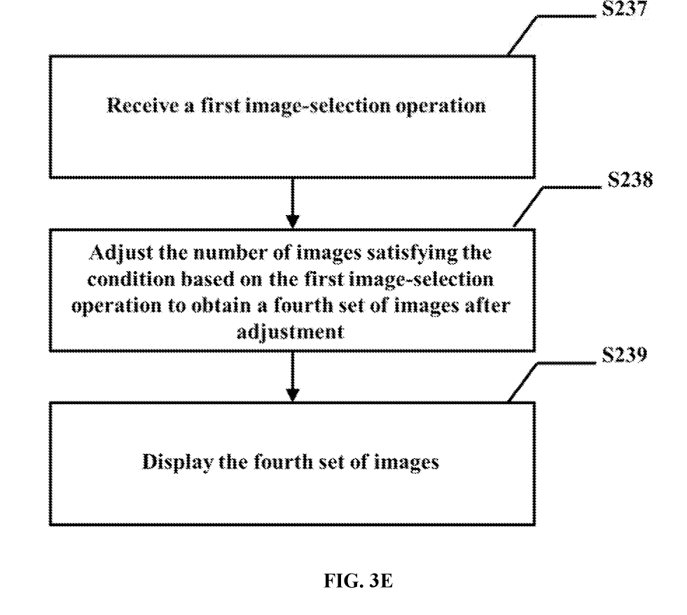

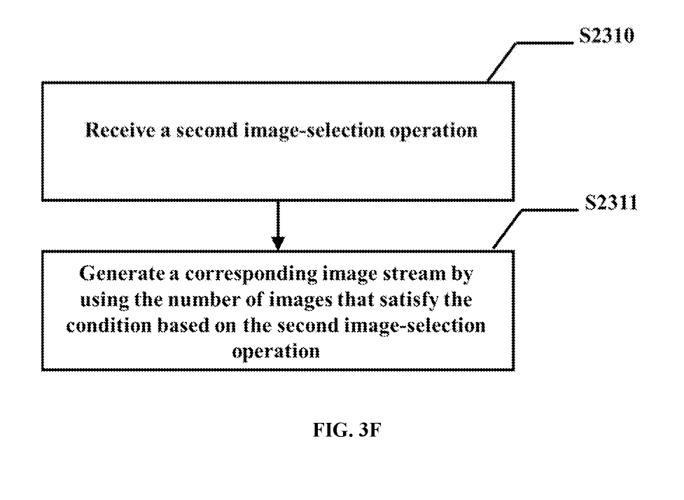

Referring to FIGS. 3A-3F, the method shown in FIG. 2 is further described with reference to some embodiments.

FIG. 3A illustrates a flowchart of displaying a number of images satisfying a condition among a first set of images according to an embodiment of the present disclosure.

As shown in FIG. 3A, displaying a number of images satisfying the condition among the first set of images may include operations S231-S233.

In S231: It is determined whether there are images containing a similar content among the first set of images.

In S232: In response to images containing the similar content among the first set of images, a second set of images are selected from the images containing the similar content.

In S233: The second set of images are displayed.

Images are accumulated in electronic devices or cloud platforms. These images generally include a plurality of types, and for a same type of images, there are usually multiple images containing the same or similar content. For example, continuous shooting may take multiple images containing the similar contents. According to an embodiment of the present disclosure, after the user inputs the search content, it may be determined whether there are images containing the same or similar content in the first set of images. In response to images containing the same or similar content in the first set of images, a second set of images may be selected from the images containing the same or similar content. The selected second set of images may be displayed. According to an embodiment of the present disclosure, the second set may be one or more, which may be determined according to actual conditions.

With the disclosed embodiments, because the second set of images are selected from images containing the same or similar content, the same or similar images can be automatically filtered. When images are displayed, not displaying the same or similar images can reduce a display space of the electronic device, such that the user is able to see a variety of images in a short time, improving the user experience. Therefore, the problem can be solved that the existing electronic devices usually display multiple images indiscriminately at the same time, resulting in a poor user experience. Further, after the user searches for a keyword to inquire images, the images may be displayed locally. When the images are stored in the cloud platform, according to embodiments of the present disclosure, the images displayed include few or do not include the same or similar image, so that the storage space of the electronic device can be saved, improving the local storage capability of the electronic device.

FIG. 3B illustrates a flowchart of a method for identifying images according to another embodiment of the present disclosure.

As shown in FIG. 3B, the method for identifying images may further include operations S240-S260.

In S240: It is determined whether there are images containing the similar content in the first set of images.

In S250: In response to images containing the similar content in the first set of images, the images containing the similar content are displayed in a first display mode.

In S260: Other images other than the images with the similar content in the first set of images are displayed in a second display mode, where the first display mode is different from the second display mode.

According to an embodiment of the present disclosure, the first display mode may be selecting an image from the images containing the same or similar content, and marking the selected image with a number of repetitions, so as to prompt the user with the number of repetitions and not display unselected images from the images containing the same or similar content. The second display mode may be displaying in a normal way, i.e. independently displaying images in the first set of images other than the images containing the same or similar content. For example, FIG. 3C illustrates a schematic view of displaying images according to an embodiment of the present disclosure. As shown in FIG. 3C, an image a, an image b, and an image c are images containing different contents, and the image a, the image b, and the image c are displayed independently. Whereas, images m1 to mx are images containing the same or similar content, among which, one image is selected for display and the selected image is marked with a number of repetition x. It should be appreciated that contents of the pictures a, b, and c may not only relate to one or more objects as displayed on the respective pictures, but may also relate to the circumstances under which the pictures a, b, and c were captured, such as date and time and/or location of the image capture.

With the disclosed embodiments, through selecting an image from the images containing the same or similar content and marking the selected image with the number of repetitions, when images are displayed, the display space of the electronic device can be reduced with more display modes are increased, and more information of the images can be displayed. Therefore, the user is able to see a variety of images in a short time, improving the user experience. Therefore, the problem can be solved that the existing electronic devices usually display multiple images indiscriminately at the same time, resulting in a poor user experience.

FIG. 3D illustrates a flowchart of displaying a number of images satisfying a condition from a first set of images according to an embodiment of the present disclosure.

As shown in FIG. 3D, displaying a number of images satisfying the condition from the first set of images may include operations S234-S236.

In S234: It is determined whether there are image having image parameters satisfying parameters in the first set of images, where the image parameters may be configured to characterize image quality of the images.

In S235: In response to images having image parameters satisfying the parameters in the first set of images, among the first set of images, a third set of images are selected from the images having image parameters satisfying the parameters.

In S236: The selected third set of images are displayed.

According to an embodiment of the present disclosure, the image parameters may be parameters such as resolution, noise, and brightness, etc. The user can set corresponding image parameters according to preference or different image quality requirements so that the displayed images can satisfy the set image parameters.

According to an embodiment of the present disclosure, in response to images having image parameters satisfying the parameters in the first set of images, among the first set of images, a third set of images are selected from the images having image parameters satisfying the parameters. The third set may be one more, which may be determined according to actual conditions.

According to embodiments of the present disclosure, through setting the image parameter requirement of the image, it is possible to filter out the images that do not satisfy the parameters so that the user can see high-quality images, and the images that are most close to the image desired by the user can be returned for the user, improving the user experience. Therefore, the problem can be solved that the existing electronic devices usually display multiple images with a low quality indiscriminately at the same time, resulting in a poor user experience.

FIG. 3E illustrates a flowchart of displaying a number of images satisfying a condition from a first set of images according to another embodiment of the present disclosure.

According to embodiments of the present disclosure, a number of images satisfying the condition may include multiple images. As shown in FIG. 3E, displaying a number of images satisfying the condition from a first set of images may include operations S237 to S239.

In S237: A first image-selection operation is received.

In S238: The number of images satisfying the condition is dynamically adjusted based on the first image selection operation, and after adjustment, a fourth set of images after adjustment are obtained.

In S239: The fourth set of images after adjustment are displayed.

According to an embodiment of the present disclosure, when displaying a number of images satisfying a condition, the number of displayed images may be adjusted according to a selection operation of the user. For example, the number of displayed images may be increased according to the operation of the user, the number of displayed images may be reduced according to the operation of the user. According to an embodiment of the present disclosure, for example, five images satisfying a condition are displayed in advance on the electronic device, which according to the selection operation of the user, may be dynamically adjusted to displaying three images. According to an embodiment of the present disclosure, for example, when five images satisfying the condition are displayed on the electronic device in advance, and if multiple images are hidden under one image, the hidden multiple images may be the same or similar image, according to the selection operation of the user, the hidden image can be dynamically adjusted so that the six or more images are displayed.

Through embodiments of the present disclosure, when the user finds that there are too large or too small number of images displayed, the number of images may be adjusted according to actual conditions, such that the number of the images can be dynamically adjusted.

FIG. 3F illustrates a flowchart of displaying a number of images satisfying a condition from a first set of images according to another embodiment of the present disclosure.

According to this embodiment, a number of images satisfying the condition may include a plurality of images. As shown in FIG. 3F, displaying a number of images satisfying the condition from a first set of images may include operations S2310 to S2311.

In S2310: A second image-selection operation is received.

In S2311: Based on the second image-selection operation, the number of images satisfying the condition are converted to a corresponding image stream.

According to an embodiment of the present disclosure, the second image-selection operation may be an operation of selecting based on shooting information of the images. Optionally, the shooting information of the images may include information such as shooting holidays, shooting weekends, shooting locations, and the like. The second image-selection operation may be based on a cross-time and cross-site selection operation. For example, if the user takes an image A on a first morning and takes an image B on the next morning. The user can search for images that are taken in the morning to get the corresponding selected images.

According to an embodiment of the present disclosure, an image may be searched and retrieved using a search keyword. The electronic device can also determine one of the descriptive sentences as a title of the image stream and return the final image stream to the user. For example, when the user searches for “sunrise”, an album interface of the electronic device may return to the user a series of images after being filtered preliminarily and further filtered by deduplication. These images may be sorted by timeline by default. A plurality of images, if selected by the user, can compose a video showing the user's upbringing, i.e. image steam, accompanied by words (crossing time and site, and presenting images showing growing up over a period of time). The accompaniment may be, for example, you are “young in heart,” because in these years, you have seen four different sunrises in Mount Hua, Mount Huangshan, Hainan and San Francisco. Images taken at a specific time, if selected by the user, may also form a short video of the specific time, accompanied by words, such as: sunrise at Mount Hua on October 1.

According to embodiments of the present disclosure, the user can select images to generate an image stream, such as a short reminiscence story film, which is based on the type of user selection operation, and therefore is cross-time and cross-site, and is not limited to a specific factor, such as festivals, weekends, and locations, etc., therefore, a need of the user can be better satisfied.

Through embodiments of the present disclosure, image albums that support types of cross-site, cross-time period, and personal history series may be generated to enhance the immersion of image browsing, and to give the user surprises. For example, the device can generate information about a certain period, during which the user has visited certain places and met certain people. The image information of the user can also be compared with that of other users, and after the comparison, a travel ranking, relationship intimacy information, travel similarity and other information can be obtained, which can further improve the user experience.

Another aspect of the present disclosure provides an electronic device, which can implement the method of retrieving images consistent with embodiments of the present disclosure. In some embodiments, the electronic device may include a processor, a memory device coupled to the processor and configured to store images, and a display device coupled to the processor and the memory device. The display device can display images stored in the memory device. In some embodiments, the electronic device may be a system.

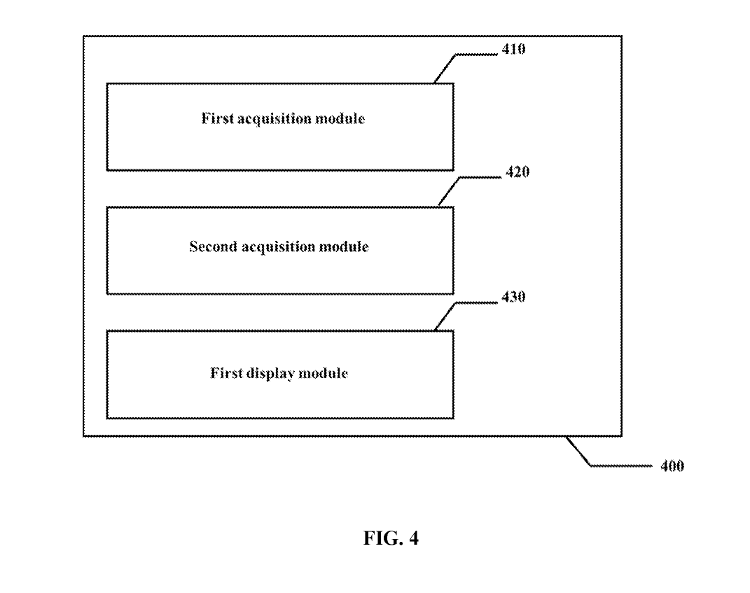

FIG. 4 illustrates a block diagram of a system 400 for identifying images according to an embodiment of the present disclosure. The system 400 may include a computer-readable memory and one or more processors. The memory can store a plurality of computer-executable instructions, which can be executed by the one or more processors.

In some embodiments, the one or more processors may include multiple modules and units. For example, as shown in FIG. 4, a system 400 for identifying images may include a first acquisition module 410, a second acquisition module 420, and a first display module 430.

The first acquisition module 410 may be configured to receive search data for identifying a target image.

The second acquisition module 420 may be configured to obtain a first set of images corresponding to the search data in a set of images based on the search data.

The first display module 430 may be configured to display a number of images satisfying a condition from a first set of images.

According to an embodiment of the present disclosure, from the first set of images, the number of images that satisfies a condition are selected to be target images. As such, a plurality of images may be selected based on a search word, and the selected images may be further filtered. Therefore, the images displayed are the images that truly satisfy the need of the user, improving the user experience.

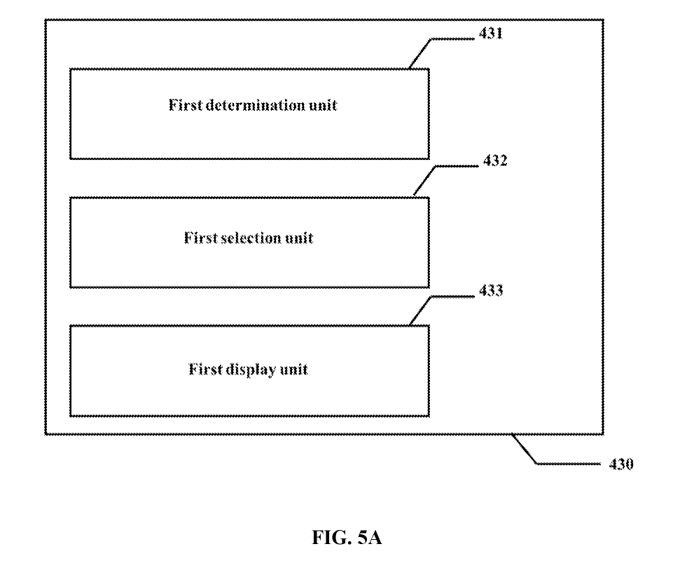

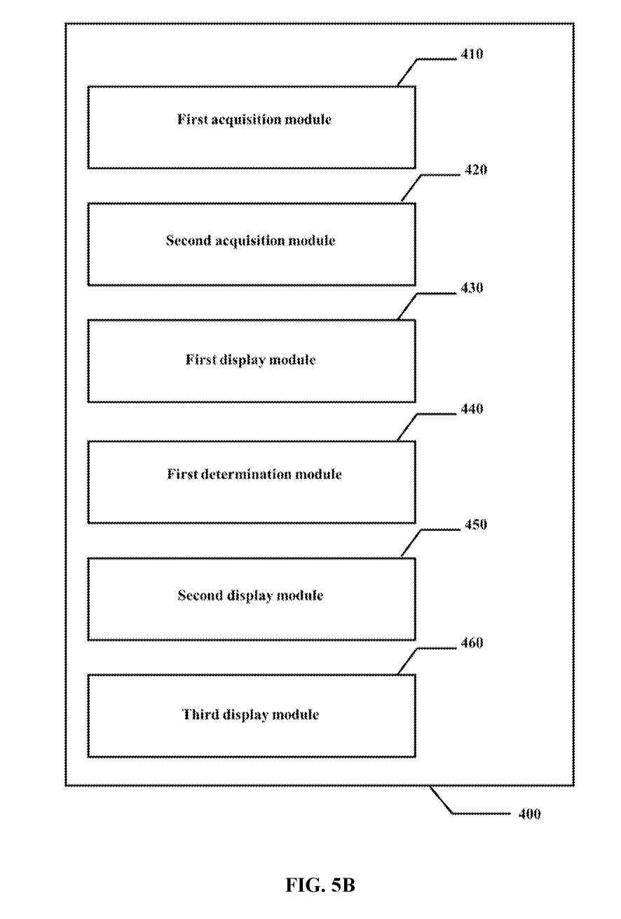

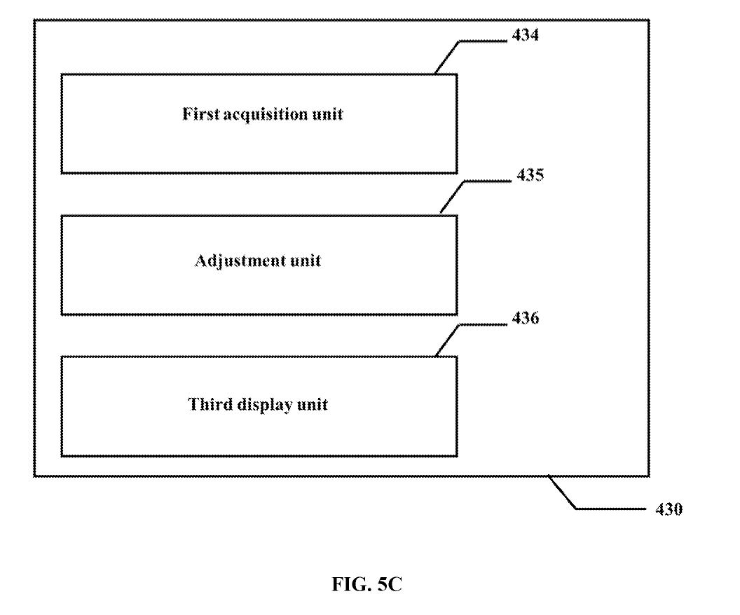

FIG. 5A illustrates a block diagram of a first display module according to an embodiment of the present disclosure.

As shown in FIG. 5A, the first display module 430 may include a first determination unit 431, a first selection unit 432, and a first display unit 433.

The first determination unit 431 may be configured to determine whether there are images containing a similar content in the first set of images.

The first selection unit 432 may be configured to select a second set of images from the images containing the same or similar content in response to images containing the similar content in the first set of images.

The first display unit 433 may be configured to display the second set of images.

With the disclosed embodiments, because the second set of images are selected from images containing the same or similar content, the same or similar images can be automatically filtered. When images are displayed, not displaying the same or similar images can reduced a display space of the electronic device, such that the user is able to see a variety of images in a short time, improving the user experience, instead of displaying multiple images indiscriminately at the same time and delivering a poor user experience. Further, after the user searches for a keyword to inquire images, the images may be displayed locally. When the images are stored in the cloud platform, according to embodiments of the present disclosure, the images displayed include few or do not include the same or similar image, so that the storage space of the electronic device can be saved, improving the local storage capability of the electronic device.

According to an embodiment of the present disclosure, the first display module 430 may include a second determination unit, a second selection unit, and a second display unit. The second determination unit may be configured to determine whether there are image having image parameters satisfying parameters in the first set of images, wherein the image parameters may be configured to represent an image quality of the images; and the second selection unit is configured to selecting among the first set of images, a third set of images from the images having image parameters satisfying the parameters, in response to images having image parameters satisfying the parameters in the first set of images; and the second display unit may be configured to display the selected third set of images.

FIG. 5B illustrates a block diagram of a system for identifying images according to another embodiment of the present disclosure.

As shown in FIG. 5B, in addition to the first acquisition module 410, the second acquisition module 420, and the first display module 430, the system 400 for identifying images may further include a determination module 440, a second display module 450, and a third display module 460.

The determination module 440 may be configured to determine whether there are images containing the similar content in the first set of images.

The second display module 450 may be configured to display the images containing the similar images in a first display mode in response to images containing the similar content in the first set of images.

The third display module 460 may be configured to display, in a second display mode, other images in the first set of images other than the images containing the similar content, where the first display mode is different from the second display mode.

With the disclosed embodiments, through selecting an image from the images containing the same or similar content and marking the selected image with the number of repetitions, when images are displayed, the display space of the electronic device can be reduced, the display modes are increased, and more information of the images can be displayed. Therefore, the user is able to see a variety of images in a short time, improving the user experience. Therefore, embodiments of the present disclosure do not display multiple images indiscriminately at the same time, and thus improve user experience.

FIG. 5C illustrates a block diagram of a first display module according to another embodiment of the present disclosure.

In this embodiment, a number of images satisfying the condition may include multiple images. As shown in FIG. 5C, the first display module 430 may include a first acquisition unit 434, an adjustment unit 435, and a third display unit 436.

The first acquisition unit 434 may be configured to receive a first image-selection operation.

The adjustment unit 435 may be configured to dynamically adjust the number of images satisfying the condition of the first image-selection operation to obtain a fourth set of images after adjustment.

The third display unit 436 may be configured to display the adjusted fourth set of images.

Through embodiments of the present disclosure, when the user finds that there are too large or too small number of images displayed, the number of images may be adjusted according to actual conditions, such that the number of the images can be dynamically adjusted.

According to an embodiment of the present disclosure, a number of images satisfying a condition may include a plurality of pieces, and the first display module 430 may include a second acquisition unit and a generation unit. The second acquisition unit may be configured to receive a second image-selection operation. The generation unit may be configured to generate a corresponding image stream by a number of images that satisfy the condition of the second image-selection operation.

It can be understood that the first acquisition module 410, the second acquisition module 420, the first display module 430, the determination module 440, the second display module 450, the third display module 460 may be combined in one module, or any one of the modules may be divided into multiple modules. Alternatively, at least some of the functions of one or more of the first acquisition module 410, the second acquisition module 420, the first display module 430, the determination module 440, the second display module 450, the third display module 460 may be combined with at least some of the functions of other modules and implemented in one module. According to an embodiment of the present disclosure, at least one of the above modules may be at least partially implemented as a hardware circuit, such as a field programmable gate array (FPGA), a programmable logic array (PLA), a system-on-chip, a system-on-substrate, a system-on-package and an application specific integrated circuit (ASIC), may be implemented in any other reasonable manner that integrates or encapsulates the circuit using hardware or firmware, or may be implemented in an appropriate combination of three forms of software, hardware, and firmware. Alternatively, at least one of the first acquisition module 410, the second acquisition module 420, the first display module 430, the determination module 440, the second display module 450, the third display module 460 may be at least partially implemented as a computer program module, and when the program is executed by a computer, the functions of the corresponding modules may be achieved.

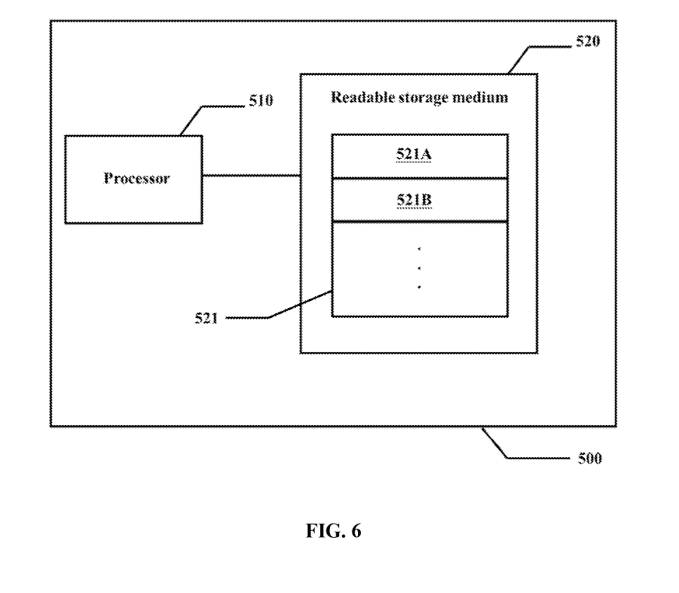

FIG. 6 illustrates a block diagram of a computer for implementing a method for identifying images according to an embodiment of the present disclosure.

As shown in FIG. 6, a computer 500 may include a processor 510 and a computer-readable storage medium 520. The computer 500 may perform the method described above with reference to FIG. 2, and FIGS. 3A-3F to achieve communication between a plurality of robots.

Specifically, the processor 510 may include, for example, a general-purpose microprocessor, an instruction-set processor, a related chip set, and/or a dedicated microprocessor (e.g., an application specific integrated circuits (ASIC)), etc. The processor 510 may also include an onboard memory for caching purposes. The processor 510 may be a single processing unit or a plurality of processing units, configured to execute different operations of the method according to embodiments of the present disclosure described with reference to FIG. 2, and FIGS. 3A-3F.

The readable storage medium 520 may be, for example, any medium that can contain, store, communicate, propagate, or transport the instructions. For example, the readable medium may include, but is not limited to, an electronic, magnetic, optical, electromagnetic, infrared, or semiconductor system, apparatus, device, or propagation medium. Specific examples of the computer-readable medium include: a magnetic storage device such as a magnetic tape or a hard disk (HDD); an optical storage device such as a compact disk read-only memory (CD-ROM); a memory such as a random-access memory (RAM) or a flash memory; and/or a cable/wireless communication link.

The readable storage medium 520 may include a computer program 521, which may include code/computer-executable instructions that, when executed by the processor 510, cause the processor 510 to execute, for example, the method described above with reference to FIG. 2, and FIGS. 3A-3F and any variations thereof.

The computer program 521 may be configured with computer program code including, for example, a computer program module. For example, in an exemplary embodiment, the code in computer program 521 may include one or a plurality of program modules including, for example, module 521A, and module 521B, etc. It should be noted that the division manners and the quantity of modules are not fixed, and those skilled in the art can use suitable program modules or program module combinations according to actual conditions. When these program module combinations are executed by the processor 510, the processor 510 can execute the method described above with reference to FIG. 2, and FIGS. 3A-3F and any variations thereof.

According to embodiments of the present disclosure, at least one of the first acquisition module 410, the second acquisition module 420, the first display module 430, the determination module 440, the second display module 450, the third display module 460 above may be implemented as the computer program module with reference to FIG. 6, which, when executed by the processor 510, may implement the corresponding operations described above.

Another aspect of the present disclosure also provides a terminal device for implementing the method for identifying images consistent with the present disclosure. For detail descriptions of the method, reference can be made to embodiments described above, e.g., the method shown in FIG. 2.

Those skilled in the art should understand that the features described in embodiments and/or claims of the present disclosure can be combined in various manners, even though such combinations are not explicitly described in the present disclosure. In particular, various combinations of features described in various embodiments and/or claims of the present disclosure may be made without departing from the spirit and teaching of the present disclosure.

All these combinations shall fall within the scope of the present disclosure.

Although the present disclosure has been shown and described with reference to specific exemplary embodiments thereof, it will be understood by those skilled in the art that without departing from the spirit and scope of the present disclosure defined by the appended claims and their equivalents, various modifications in form and detail may be made to the present disclosure. Therefore, the scope of the present disclosure should not be limited to the above-described embodiments but should be determined not only by the appended claims but also by the equivalents of the appended claims.

What is claimed is:

1. A method for retrieving stored images in an electronic device, the method comprising:
obtaining an image selected from among the stored images;
determining a target content of the selected image;
identifying one or more images from among the stored images that corresponding to the target content of the selected image; and
displaying the one or more identified images.

2. The method according to claim 1, further comprising:
determining whether there are images containing a similar content in the one or more identified images, the one or more identified images being a first set of images;
selecting one or more display images from the images containing the similar content; and
displaying the one or more display images.

3. The method according to claim 1, further comprising:
determining whether there are images with a similar content in the one or more identified images;
displaying, in a first display mode, the images containing the similar content; and
displaying, in a second display mode, images other than the images containing the similar content in the one or more identified images, wherein the first display mode is different from the second display mode.

4. The method according to claim 1, further comprising:
determining whether there are images having image parameters satisfying parameters in the one or more identified images, wherein the image parameters characterize image quality of the images;
selecting, from the images having image parameters satisfying the parameters among the one or more identified images, one or more display images, in response to images having the image parameters satisfying the parameters in the one or more identified images; and
displaying the one or more display images.

5. The method according to claim 1, further comprising:
receiving a first image-selection operation;
adjusting a quantity of one or more display images selected from the one or more identified images according to the first image-selection operation to obtain the one or more display images; and
displaying the one or more display images.

6. The method according to claim 1, wherein the one or more identified images includes multiple images, and displaying the one or more identified images includes:
receiving a second image-selection operation; and
generating a corresponding image stream by using the one or more identified images according to the second image-selection operation.

7. An electronic device, comprising:
a processor;
a memory device coupled to the processor and configured to store images; and
a display device coupled to the processor and the memory device, the display device being configured to display the images as stored in the memory device,
wherein the processor is configured to:
obtain an image selected from the images stored in the memory device;
determine a target content of the selected image;
identify the one or more images from the memory device that correspond to the target content of the selected image; and
send the one or more identified images to the display device for displaying.

8. The electronic device according to claim 7, wherein the processor is further configured to:
determine whether there are images containing a similar content in the one or more identified images;
select one or more display images from the images containing the similar content, in response to images containing the similar content in the one or more identified images; and
send the one or more display images to the display device for displaying.

9. The electronic device according to claim 7, wherein the processor is further configured to:
determine whether there are images containing the similar content in the one or more identified images;
send the images containing the similar content to the display device for displaying in a first display mode, in response to images containing the similar content in the one or more identified images; and
send other images in the one or more identified images other than the images containing the similar content to the display device for displaying in a second display mode, wherein the first display mode is different from the second display mode.

10. The electronic device according to claim 7, wherein the processor is further configured to:
receive a first image-selection operation;
dynamically adjust a quantity of one or more display images selected from the one or more identified images according to the first image-selection operation to obtain the one or more display images; and
send the one or more display images to the display device for displaying.

11. A terminal device comprising:
a processor; and
a memory coupled to the processor and storing instructions that, when executed by the processor, cause the processor to:
obtain an image selected from stored images;
determine a target content from the selected image;
identify one or more images from among the stored images that corresponding to the target content of the selected image; and
display of the one or identified images.

12. The terminal device according to claim 11, wherein the process is configured to:
determine whether there are images containing a similar content in the one or more identified images;
select one or more display images from the images containing the similar content; and
display the one or more display images.

13. The terminal device according to claim 11, wherein the process is configured to:
determine whether there are images with similar content in the one or more identified images;
display, in a first display mode, the images containing the similar content; and
display, in a second display mode, images other than the images containing the similar content in the one or more identified images, wherein the first display mode is different from the second display mode.

14. The terminal device according to claim 11, the process is configured to:
determine whether there are image having image parameters satisfying parameters in the one or more identified images, wherein the image parameters characterize image quality of the images;
select, from the images having image parameters satisfying the parameters among the one or more identified images, one or more display images, in response to images having the image parameters satisfying the parameters in the one or more identified images; and
display the one or more display images.

15. The terminal device according to claim 11, the processor is configured to:
receive a first image-selection operation;
adjust a quantity of one or more display images selected from the one or more identified images according to the first image-selection operation to obtain the one or more display images; and
display of the one or more display images.

16. The terminal device according to claim 11, the processor is configured to:
receive a second image-selection operation; and
generate a corresponding image stream by using the one or more identified images according to the second image-selection operation.
